(19) United States
(12) Patent Application Publication
(10) Pub. No.: US 2004/0047075 A1
(43) Pub. Date: Mar. 11, 2004

(54) Magnetic disk cartridge

(75) Inventor: Hideaki Shiga, Odawara-shi (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/656,282

(22) Filed: Sep. 8, 2003

(30) Foreign Application Priority Data
Sep. 10, 2002 (JP) 264206/2002

(51) Int. Cl. G11B 23/03

(52) U.S. Cl. 360/133

(57) ABSTRACT

In order to reduce manufacturing costs of a relatively thick center core with an outside diameter of 15 mm or less and to achieve high precision flatness of a disk affixing surface and a spindle chucking surface of the center core, the center core is manufactured by only pressing or a combination of forging and pressing a stainless steel material with good surface precision and parallelism between the surface.

### BACKGROUND OF THE INVENTION

1. Field of the Invention

The present invention relates to a magnetic disk cartridge and, more particularly, to a center core of a magnetic disk cartridge which houses a flexible disk with the center core.

2. Description of the Related Art

A magnetic disk cartridge which houses a magnetic disk medium (floppy (Trademark) disk) in a flat case has been conventionally provided. The magnetic disk medium has a magnetic layer on each side of a discoid base made of a flexible polyester sheet or the like, and a magnetic head performs magnetic recording on the magnetic layers while the magnetic disk medium is rotationally driven. Since the magnetic disk cartridge is easy to handle and inexpensive to manufacture, the magnetic disk cartridge has been used mainly as a recording medium for computers.

This type of magnetic disk cartridge has a center core fixed to the center of the magnetic disk medium. The center core concentrically includes a spindle aperture and a flange. A spindle of a disk drive is inserted into the spindle aperture, and the magnetic disk medium is affixed to one side of the flange.

Different types of recording media are placed in card slots of electronic equipment such as digital still cameras, digital video cameras and laptop computers, and recording/reproducing is performed thereon. The recording media can be inserted and ejected. For these recording media, various types of recording media including a semiconductor memory, a hard disk, an optical disk, a magnetic disk including a floppy (Trademark) disk, and the like are currently used. Nevertheless, large-capacity magnetic disk cartridges, smaller than the floppy (Trademark) disk in size, have been recently proposed as media which can be placed in personal computers, digital cameras and the like. For these magnetic recording media with a high recording density, it is possible to employ a medium coated with a thin metal film formed through evaporation or sputtering, a medium to which barium ferrite powder or ferromagnetic powder is applied, and the like. There has been proposed a particular example of the medium in which the barium ferrite powder is used (Japanese Patent Application No. 2001-312864).

Incidentally, since the foregoing small-size magnetic disk cartridge has been demanded to have a large storage capacity, the storage capacity must be secured to the maximum feasible extent through high density recording. Moreover, in order to perform recording and reproducing with high precision, it is required to prevent wobbling of a rotating flexible disk within the magnetic disk cartridge to stabilize recording characteristics. Therefore, a thick high precision center core has been proposed.

In addition, the center core is made of iron-based metal to be chucked in a manner that the center core is magnetically attracted to a spindle of the disk drive. A relatively thick center core has been employed to compensate for deficient magnetic attraction due to the small center core with the outside diameter of 15 mm or less.

FIG. 5 shows a sectional view of such a conventional center core. The thickest portion of the relatively thick conventional center core compared to the diameter is from 0.5 mm to 1.8 mm inclusive, and preferably from 0.8 mm to 1.5 mm inclusive. The center core has an affixing surface with respect to the flexible disk on an upper surface thereof and a portion engaging with the spindle of the disk drive on a lower surface thereof. The center core is processed to taper in an outer circumferential portion a, becoming thinner outwards in a radial direction. Furthermore, it is required to precisely process the upper and lower surfaces b and c in order to stabilize recording characteristics during disk rotation. In other words, both flatness of the upper and lower surfaces b and c and parallelism therebetween have been demanded to be highly precise.

Nonetheless, the manufacture of the conventional center core has had a problem of high manufacturing costs because a cylindrical bar member was lathed to be cut off, i.e., it took a long time to process the center core, and a cutting stock thereof was large. Moreover, there has been another problem that qualities of the center cores vary in mass production since it has been difficult to highly improve the precision of the flatness of the upper surface b serving as a disk affixing surface and the lower surface c serving as an engaging surface with a spindle, and it has also been difficult to achieve the high precision of the parallelism between the surfaces b and c.

### SUMMARY OF THE INVENTION

In consideration of the aforementioned circumstances, an object of the present invention is to provide a magnetic disk cartridge capable of reducing manufacturing costs and highly improving the precision of the flatness of the disk affixing surface and spindle engaging surface (chucking surface), in manufacturing of the relatively thick small-size center core as described above.

The magnetic disk cartridge of the present invention is constituted by rotatably housing a discoid flexible disk and a center core affixed to the rotational center of the flexible disk. The magnetic disk cartridge is characterized in that the center core is processed by only pressing or a combination of forging and pressing a planar material with at least predetermined flatness and parallelism.

The outside diameter of the center core of the present invention is 15 mm or less. The thickness of the planar material is from 0.4 mm to 1.0 mm inclusive, and preferably from 0.4 mm to 0.8 mm inclusive in the case of pressing only. In the case of the combination of forging and pressing, the thickness of the planar material is from 0.4 mm to 1.8 mm inclusive, and preferably from 0.6 mm to 1.2 mm inclusive.

The “at least predetermined flatness and parallelism” means that the flatness and parallelism enable recording characteristics to be stabilized by preventing the wobbling of the affixed flexible disk during rotation. The flatness is preferably 0.015 mm or less, and more preferably 0.010 mm or less. Relative to a reference surface of the disk drive, the parallelism is preferably 0.020 mm or less, more preferably 0.015 mm or less, and most preferably 0.010 mm or less when the magnetic disk cartridge is set in the disk drive.

Furthermore, the center core preferably has a surface substantially perpendicular to the flexible disk affixing surface, at least on a part of the outer circumferential surface. Moreover, in the case of the combination of forging and pressing, the center core preferably has a tapered portion on the lower surface thereof, which becomes thinner outwards in a radial direction. In this case, the center core is preferably processed as follows: the outer and inner circumferential surfaces of the center core are formed by pressing; the tapered portion is formed by forging; and two ridges are cropped by pressing. One ridge is a juncture of the flexible disk affixing surface and the inner circumferential surface. The other ridge is a juncture of the flexible disk affixing surface and the outer circumferential surface.

According to the magnetic disk cartridge of the present invention, the center core is processed either by only pressing or by the combination of forging and pressing. Accordingly, it is possible to reduce the manufacturing costs. In other words, according to the pressing or the combination of the forging and the pressing, it takes substantially shorter time than that of lathing to process the center core. Moreover, since it is possible to make use of most parts of the material, the manufacturing costs can be reduced even if there is an extra cost of manufacturing dies required in pressing and forging.

Moreover, since the planar material with at least the predetermined flatness and parallelism is employed, it becomes easy to produce the high precision flatness of the disk affixing surface by making use of one surface of the planar material as the disk affixing surface and the other surface as the spindle chucking surface. The planar material with at least the predetermined flatness and parallelism can employ a planar metal material with good surface precision on its own. Therefore, the planar material can be obtained at low cost.

### BRIEF DESCRIPTION OF THE DRAWINGS

FIGS. 1A and 1B are perspective views schematically showing the front and back of a magnetic disk cartridge of the present invention, respectively.

FIG. 2 is an enlarged sectional view showing a center of the magnetic disk cartridge according to the present invention, which includes a center core fabricated by a combination of forging and pressing.

FIGS. 3A to 3D are views illustrating steps of processing the center core in FIG. 2.

FIGS. 4A and 4B are sectional views showing the center core fabricated by only pressing.

FIG. 5 is a sectional view showing a conventional center core.

### DESCRIPTION OF THE PREFERRED EMBODIMENTS

Embodiments of a magnetic disk cartridge according to the present invention will be described below with reference to the attached drawings. Note that the ratio of the dimensions of each constituent part is different from the actual ones in order to facilitate understanding.

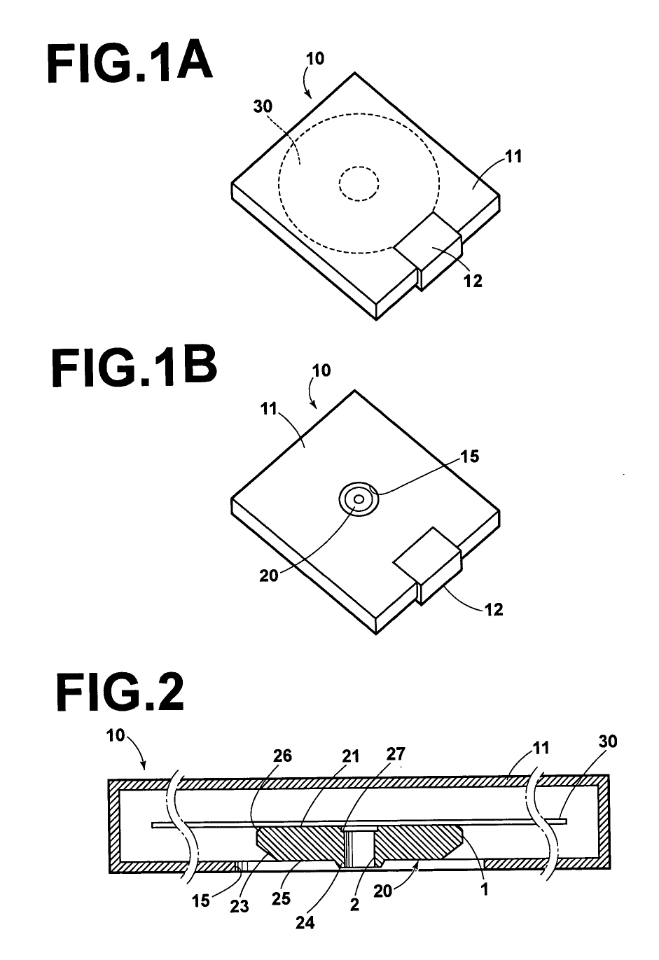

In FIGS. 1A and 1B, a magnetic disk cartridge 10 rotatably houses a flexible magnetic disk 30 in a flat quadrilateral housing 11. The housing 11 has the thickness of, for example, approximately 2 mm to 3 mm and is made of plastic, a metal material which blocks magnetism, or the like. An opening (not shown) and a shutter 12 are provided at one end of the housing 11. The opening is for allowing a magnetic head of a disk drive to access the flexible disk 30, and the shutter 12 slides to open and close the opening.

As shown in FIG. 2, a center core 20 with an outside diameter of 15 mm or less is attached to the center of the magnetic disk 30. An opening 15 is formed at the center on the back of the housing 11 so that the center core 20 faces the exterior. When the magnetic disk cartridge 10 is placed in the disk drive, a driving spindle enters the opening 15 and engages with a lower surface 25 of the center core 20 to rotate the flexible disk 30. At the same time, the shutter 12 is opened to allow the magnetic head to access the flexible disk 30, and information is recorded and reproduced.

The center core 20 is formed by forging and pressing a planar stainless steel-based material, such as SUS430 series or ASTM XM-6 series. The thickness of the planar material is from 0.4 mm to 1.8 mm inclusive, and preferably from 0.6 mm to 0.8 mm inclusive. The flatness of upper and lower surfaces thereof is 0.015 mm or less, and preferably 0.010 mm or less. The parallelism between the upper and lower surfaces is 0.020 mm or less, preferably 0.015 mm or less, and more preferably 0.010 mm or less, with respect to a reference plane.

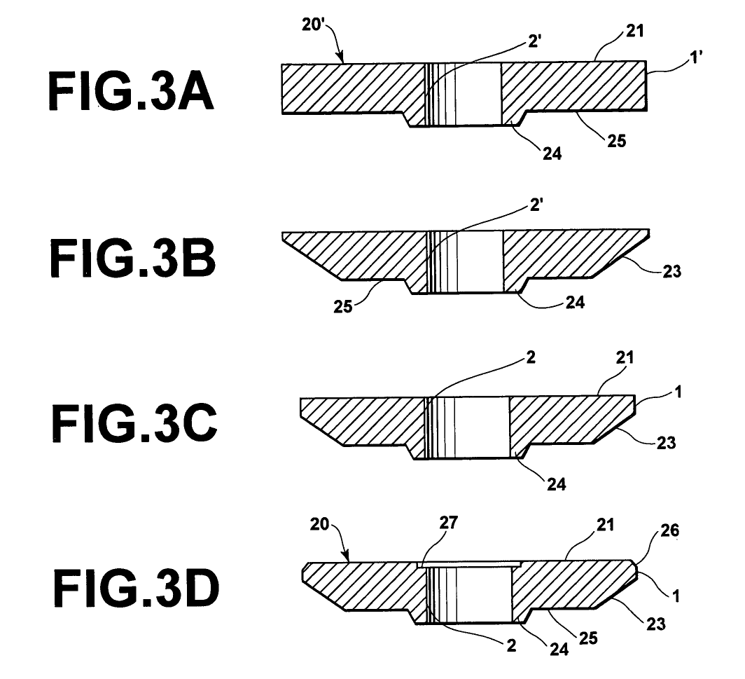

Next, the steps of processing the center core 20 will be described with reference to FIGS. 3A to 3D. FIG. 3A shows the center core 20 after the steps of stamping the inner and outer circumferences and forging the lower center portion. FIG. 3B shows the center core 20 after the step of forging. FIG. 3C shows the center core 20 after the step of stamping. FIG. 3D shows the center core 20 after the step of cropping.

First, the planar material is stamped. A bump 24 is created on the periphery of the center aperture on the lower surface 25 by forging to form a center core pre-form 20′ having outer and inner circumferential surfaces 1′ and 2′ as shown in FIG. 3A. Note that at this point in time, the inner circumferential surface 2′ leaves a finishing portion for a later step, finishing stamping, as shown in FIG. 3C.

Second, a tapered portion 23 is formed on the outer circumferential side of the lower surface 25 in the forging step illustrated in FIG. 3B, becoming thinner outwards in a radial direction. At this time, the outside diameter is enlarged.

Third, the inner and outer circumferences are finished by finishing stamping in the stamping step in FIG. 3C. Accordingly, the outer and inner circumferential surfaces 1 and 2 are finally formed, which are substantially perpendicular to an upper surface 21 serving as a disk affixing surface.

Finally, ridges of junctures between the disk affixing surface 21 and the outer circumferential surface 1, and between the disk affixing surface 21 and the inner circumferential surface 2 are cropped in the cropping step as illustrated in FIG. 3D to form cropped portions 26 and 27, respectively.

As described above, the center core 20 with the surface 1 substantially perpendicular to the upper surface 21 (disk affixing surface) can be produced. Note that the width of the surface 1 is 0.1 mm or more, and preferably 0.2 mm or more in a vertical direction.

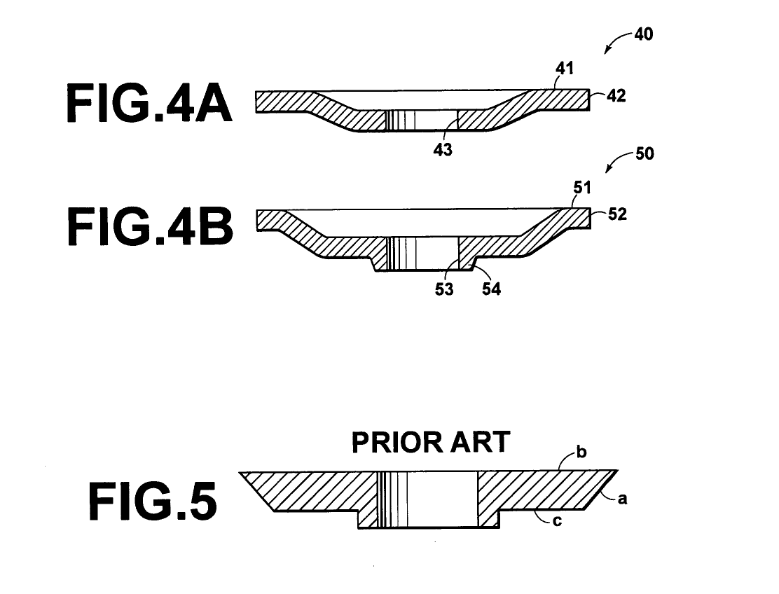

FIGS. 4A and 4B are sectional views, each showing a center core formed by only pressing a planar material. The planar material employed in this case also has the same flatness and parallelism as those of the aforementioned planar material. However, the thickness of the planar material in this case is from 0.4 mm to 1.0 mm inclusive, and preferably from 0.4 mm to 0.8 mm inclusive.

A center core 40 shown in FIG. 4A is bent so as to position the outer rim portion above the central portion when seen in the sectional view. An upper surface 41 of the outer rim portion is a disk affixing surface. Outer and inner circumferential surfaces 42 and 43 are substantially perpendicular to the upper surface 41.

Furthermore, a center core 50 shown in FIG. 4B is also bent so as to position the outer rim portion above the central portion when seen in the sectional view. An upper surface 51 of the outer rim portion is a disk affixing surface, and the center core 50 has outer and inner circumferential surfaces 52 and 53 substantially perpendicular to the upper surface 51. However, the center core 50 is different from the center core 40 shown in FIG. 4A in that the center core 50 is provided with a bump 54 at the periphery of a center hole on the lower surface.

According to the magnetic disk cartridge of the present invention thus constituted, the center cores 20, 40 and 50 are formed by only pressing or a combination of pressing and forging. Thus, the manufacturing costs of the center core can be reduced. In addition, since stainless steel with good surface precision is used as the planar material, the flatness of the disk affixing surface 21 and the spindle engaging surface 25 can be highly precise.

Note that applicable materials to the center core in the magnetic disk cartridge of the present invention are not limited to stainless steel although stainless steel has been employed as the planar material in the embodiments described above.

What is claimed is:

1. A magnetic disk cartridge rotatably housing a discoid flexible disk and a center core affixed to a rotation center of the flexible disk,
wherein the center core is processed by only pressing or a combination of forging and pressing a planar material having at least predetermined flatness and parallelism.

2. The magnetic disk cartridge according to claim 1, wherein thickness of the planar material is from 0.4 mm to 1.0 mm inclusive, and an outside diameter of the center core is 15 mm or less.

3. The magnetic disk cartridge according to claim 1, wherein thickness of the planar material is from 0.4 mm to 0.8 mm inclusive, and an outside diameter of the center core is 15 mm or less.

4. The magnetic disk cartridge according to claim 1, wherein the flatness of the planar material is 0.015 mm or less, and the parallelism is 0.02 mm or less relative to a reference surface.

5. The magnetic disk cartridge according to claim 1, wherein the flatness of the planar material is 0.010 mm or less, and the parallelism is 0.015 mm or less relative to a reference surface.

6. The magnetic disk cartridge according to claim 1, wherein the flatness of the planar material is 0.010 mm or less, and the parallelism is 0.010 mm or less relative to a reference surface.

7. The magnetic disk cartridge according to claim 1, wherein a part of an outer circumferential surface of the center core includes a surface substantially perpendicular to an affixing surface of the center core to the flexible disk.

8. A magnetic disk cartridge rotatably housing a discoid flexible disk and a center core affixed to a rotation center of the flexible disk,
wherein the center core is processed by a combination of forging and pressing a planar material having at least predetermined flatness and parallelism.

9. The magnetic disk cartridge according to claim 8, wherein thickness of the planar material is from 0.4 mm to 1.8 mm inclusive, and an outside diameter of the center core is 15 mm or less.

10. The magnetic disk cartridge according to claim 8, wherein thickness of the planar material is from 0.6 mm to 1.2 mm inclusive, and an outside diameter of the center core is 15 mm or less.

11. The magnetic disk cartridge according to claim 8, wherein the flatness of the planar material is 0.015 mm or less, and the parallelism is 0.02 mm or less relative to a reference surface.

12. The magnetic disk cartridge according to claim 8, wherein the flatness of the planar material is 0.010 mm or less, and the parallelism is 0.015 mm or less relative to a reference surface.

13. The magnetic disk cartridge according to claim 8, wherein the flatness of the planar material is 0.010 mm or less, and the parallelism is 0.010 mm or less relative to a reference surface.

14. The magnetic disk cartridge according to claim 8, wherein the center core includes a tapered portion which becomes thinner outwards in a radial direction, and a part of an outer circumferential surface of the center core includes a surface substantially perpendicular to an affixing surface of the center core to the flexible disk.
